(19) United States
(12) Patent Application Publication
(10) Pub. No.: US 2013/0173498 A1
(43) Pub. Date: Jul. 4, 2013

(54) CALCULATION OF ACCURATE COSTS OF TRANSFERS BETWEEN COST GROUPS

(71) Applicant: Anup Kumar Jha, Foster City, CA (US)

(72) Inventor: Anup Kumar Jha, Foster City, CA (US)

(73) Assignee: Oracle International Corporation, Redwood Shores, CA (US)

(21) Appl. No.: 13/339,653

(22) Filed: Dec. 29, 2011

(51) Int. Cl. G06Q 30/02

(52) U.S. Cl. 705/400

(57) ABSTRACT

Various arrangements for calculating costs of transferable items in accordance with an iterative periodic average costing model are presented. Indications of a plurality of transfers of transferable items among cost groups of a plurality of cost groups may be received. A plurality of matrices may be created. Elements of each matrix may correspond to iterative periodic average costing equations evaluated for the infinite iteration using the plurality of transfers of transferable items among cost groups and the plurality of cost groups. The cost of each transferable item within each cost group of the plurality of cost groups may be calculated using the plurality of matrices having the elements of each matrix corresponding to the iterative periodic average costing equations evaluated for the infinite iteration.

### BACKGROUND

A business may transfer items, such as raw materials, among various locations of the business. When such items are transferred among different locations, a way of accounting for the cost of the items at the different locations may be needed. One type of accounting model used is periodic average costing (PAC). In periodic average costing, the cost of items and the associated transactions are calculated on a periodic basis. The following methods of PAC may typically be used: 1) use the transfer price (a negotiated price between two locations of a business); 2) use costs determined for the item during a previous period; 3) use a perpetual cost; or 4) use an iterative method for calculating the cost of items at various locations. The first three methods typically result in an approximation that does not reflect the exact cost of the item. This may result in a financial statement of the business either overstating or understating a value of the item.

Use of the fourth method, iterative periodic average costing, may be the preferable way of calculating a cost of an item. For example, financial regulations may stipulate that this method is to be used in certain jurisdictions. As the number of locations between which a business may transfer items increases, the amount of calculation to perform iterations of an iterative periodic average costing method may increase. As such, performing multiple iterations may be computationally expensive and/or time-consuming. Accordingly, businesses may tend to perform insufficient iterations to obtain an accurate estimate of the cost of the items. This, like the other periodic average costing methods, may result in financial statements that may (significantly) overstate or understate the value of the transferrable items.

### SUMMARY

In some embodiments, a method for calculating costs of transferable items in accordance with an iterative periodic average costing model is presented. The method may include receiving, by a computer system, indications of a plurality of transfers of transferable items among cost groups of a plurality of cost groups. The method may include creating, by the computer system, a plurality of matrices. Elements of each matrix may correspond to iterative periodic average costing equations evaluated for an infinite iteration using the plurality of transfers of transferable items among cost groups of the plurality of cost groups. The method may include calculating, by the computer system, a cost of each transferable item within each cost group of the plurality of cost groups using the plurality of matrices having the elements of each matrix corresponding to the iterative periodic average costing equations evaluated for the infinite iteration.

Various embodiments of such a method may include one or more of the following: Each row of a matrix of the plurality of matrices may correspond to a different cost group of the plurality of cost groups. Each cost group of the plurality of cost groups may correspond to a different row of the matrix of the plurality of matrices. An element within a row of the matrix of the plurality of matrices may indicate an initial quantity of transferable items within a cost group of the plurality of cost groups added with a quantity of transferable items received by the cost group from other cost groups of the plurality of cost groups. A second element within the row of the matrix may indicate a second quantity of transferable items received from another cost group of the plurality of cost groups. Calculating the cost of transferable items within each cost group of the plurality of cost groups using the plurality of matrices may comprise calculating an inverse of the matrix to create an inverted matrix.

Further, various embodiments of such a method may include one or more of the following: Calculating the cost of the transferable items within each cost group of the plurality of cost groups using the plurality of matrices having rows evaluated for the infinite iteration may further comprise multiplying the inverted matrix by a second matrix of the plurality of matrices, wherein an element of the second matrix corresponds to an initial quantity of transferrable items and an initial cost of transferable items of a cost group of the plurality of cost groups. Each cost group of the plurality of cost groups may represent a different physical location. Calculating the cost of transferable items within each cost group of the plurality of cost groups using the plurality of matrices having the elements of each matrix corresponding to the iterative periodic average costing equations evaluated for the infinite iteration may result in the same costs as calculating an infinite number of iterations of iterative periodic average costing equations.

In some embodiments, a computer program product residing on a non-transitory processor-readable medium for calculating costs of transferable items in accordance with an iterative periodic average costing model is presented. The computer program product may comprise computer-readable instructions configured to cause a computer to receive indications of a plurality of transfers of transferable items among cost groups of a plurality of cost groups. The computer program product may comprise computer-readable instructions configured to cause the computer to create a plurality of matrices. Elements of each matrix may correspond to iterative periodic average costing equations evaluated for an infinite iteration using the plurality of transfers of transferable items among cost groups of the plurality of cost groups. The computer program product may comprise computer-readable instructions configured to cause the computer to calculate a cost of each transferable item within each cost group of the plurality of cost groups using the plurality of matrices having the elements of each matrix corresponding to the iterative periodic average costing equations evaluated for the infinite iteration.

Various embodiments of such a computer program may include one or more of the following: A first row of a matrix of the plurality of matrices may correspond to a first cost group of the plurality of cost groups. A second row of the matrix of the plurality of matrices may correspond to a second cost group of the plurality of cost groups. Each cost group of the plurality of cost groups may correspond to a corresponding row of the matrix of the plurality of matrices. An element within the first row of the matrix of the plurality of matrices may indicate an initial quantity of transferable items within the first cost group of the plurality of cost groups added with a quantity of transferable items received by the first cost group from other cost groups of the plurality of cost groups. Each other element within each row of the matrix may indicate a second quantity of transferable items received from each other cost group of the plurality of cost groups. The computer-readable instructions configured to cause the computer to calculate the cost of the transferable items within each cost group of the plurality of cost groups using the plurality of matrices may further comprise computer-readable instructions configured to cause the computer to calculate an inverse of the matrix to create an inverted matrix. The computer-readable instructions configured to cause the computer to calculate the cost of the transferable items within each cost group of the plurality of cost groups using the plurality of matrices having rows evaluated for the infinite iteration may further comprise computer-readable instructions configured to cause the computer to multiply the inverted matrix by a second matrix of the plurality of matrices, wherein each element of the second matrix corresponds to an initial quantity of transferrable items and an initial cost of transferable items of a corresponding cost group of the plurality of cost groups. Each cost group of the plurality of cost groups may represent a different physical location.

In some embodiments, a system for calculating costs of transferable items in accordance with an iterative periodic average costing model is presented. The system may include a computer system. The computer system may include a processor and a memory communicatively coupled with and readable by the processor and having stored therein processor-readable instructions. When executed by the processor, the processor-readable instructions may cause the processor to receive indications of a plurality of transfers of transferable items among cost groups of a plurality of cost groups. The processor-readable instructions may also cause the processor to create a plurality of matrices. Elements of each matrix may correspond to iterative periodic average costing equations evaluated for an infinite iteration using the plurality of transfers of transferable items among cost groups and the plurality of cost groups. The processor-readable instructions may also cause the processor to calculate a cost of each transferable item within each cost group of the plurality of cost groups using the plurality of matrices having the elements of each matrix corresponding to the iterative periodic average costing equations evaluated for the infinite iteration.

Various embodiments of such a system may include one or more of the following: Each row of a matrix of the plurality of matrices may correspond to a corresponding cost group of the plurality of cost groups. Each cost group of the plurality of cost groups may correspond to a corresponding row of the matrix of the plurality of matrices. Elements within each row of the matrix of the plurality of matrices may indicate an initial quantity of transferable items within a corresponding cost group of the plurality of cost groups added with a quantity of transferable items received by the corresponding cost group from other cost groups of the plurality of cost groups. Each other element within each row of the matrix may indicate a second quantity of transferable items received from each other cost group of the plurality of cost groups. The processor-readable instructions configured to cause the processor to calculate the cost of the transferable items within each cost group of the plurality of cost groups using the plurality of matrices further may comprise processor-readable instructions configured to cause the processor to calculate an inverse of the matrix to create an inverted matrix.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A illustrates an embodiment of transfers of items between locations.

FIG. 1B illustrates an embodiment of transfers of items between multiple cost groups.

FIG. 2 illustrates an embodiment of a system for creating and using a matrix based on an iterative periodic average costing equation evaluated for the infinite iteration for accounting purposes.

FIG. 3 illustrates an embodiment of a method for creating and using a matrix based on an iterative periodic average costing equation evaluated for the infinite iteration.

FIG. 4 illustrates an embodiment of a method for using a matrix based on an iterative periodic average costing equation evaluated for the infinite iteration to determine costs of transferable items.

FIG. 5 illustrates another embodiment of a method for using a matrix based on an iterative periodic average costing equation evaluated for the infinite iteration to determine costs of transferable items.

FIG. 6 illustrates an embodiment of a computer system.

### DETAILED DESCRIPTION

When an iterative periodic average costing (PAC) method is used, the greater number of iterations performed of the associated equations, the more accurate the calculated cost values of transferrable items become. However, many businesses (or other entities) that desire to calculate the cost of transferable items located at multiple locations using an iterative PAC tend to perform an insufficient number of iterations. This may be due to time. As the number of locations between which transferrable items are transferred increases, the amount of computation to perform each iteration of iterative PAC equations may significantly increase. As such, only one or two iterations may be performed.

Such a number of iterations may not provide an accurate result of the cost of the transferable items. As such, calculation of the cost of transferrable items among multiple locations may be desired using an iterative PAC method that is more accurate and/or can be calculated more efficiently (e.g., faster and/or using less computation resources).

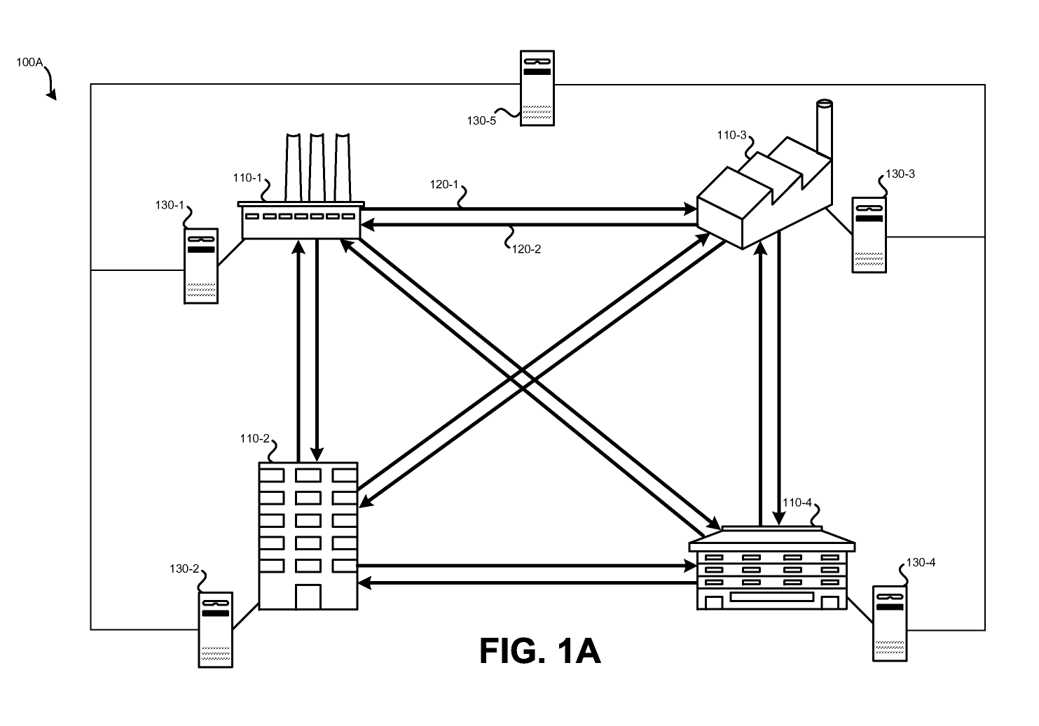

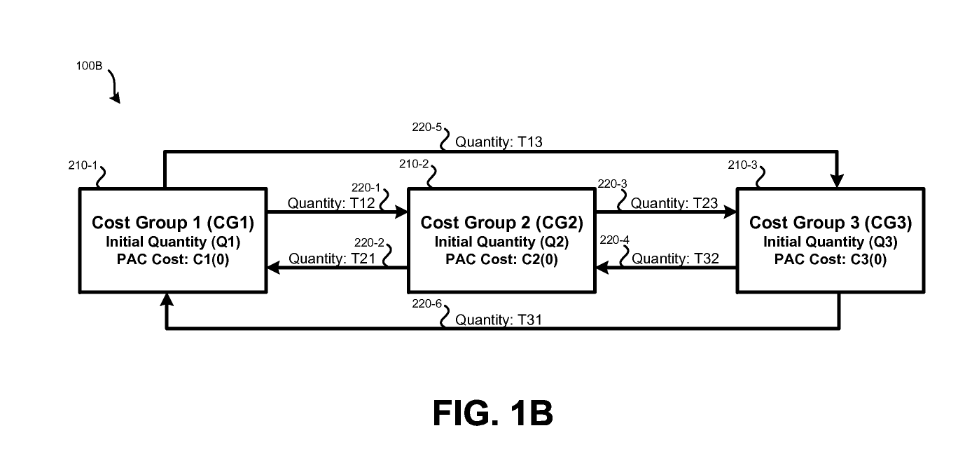

FIG. 1A illustrates an embodiment 100A of transfers of items between locations. In FIG. 1A, multiple items may be transferred among multiple locations 110. Each of the multiple items transferred may be the same type of item. For example, each item, also referred to as a transferrable item, may be a unit of a raw material, a product, or some other item that is present at multiple locations 110 of a business or other entity. Therefore, an item at one location may be treated as identical to items at other locations.

Each location 110 may be a different physical location of a business or some other type of entity. Locations 110 may be in different buildings, cities, states, countries, or continents. For whatever reason, transferable items may be moved among the various locations. For accounting purposes, the cost of these items at each location may need to be determined. In embodiment 100, transferrable items are moved from each location to each other location. For example, transit arrow 120-1 illustrates a number of transferrable items being moved from location 110-1 to location 110-3. In embodiment 100, as illustrated by transit arrows 120 (for simplicity, only transit arrows 120-1 and 120-2 are labeled), transferrable items are transferred between each location and each other location of locations 110. It should be understood that each location may not receive and send items to each other location; rather, only some of locations 110 may receive items and/or only some of locations 110 may send items to other locations. Associated with each transit arrow 120 may be a number of items. For example, during a particular period of time, such as a quarter of a fiscal year, 500 items may be transferred from location 110-1 to location 110-3, as indicated by transit arrow 120-1. During this same period of time, 40 of the same type of item may be transferred from location 110-3 to location 110-1 as indicated by transit arrow 120-2.

Computer systems 130 may be located at some or all of locations 110. Such computer systems 130 may be used to monitor the quantities of items transferred among locations 110. Computer systems 130 may also be used to monitor initial quantities at the beginning of time periods and the initial costs of items at locations 110. Periodically, computer system 130-5, which may be a centralized computer system, may receive an indication of the transfers among locations 110, quantities, and costs from other computer systems of computer systems 130. Centralized computer system 130-5 may also be one of computer systems 130-1, 130-2, 130-3, or 130-4. Computer system 130-5 may use the data received from other computer systems to calculate the cost of items using a periodic average costing method. Such computed costs may be added to one or more financial statements by computer system 130-5. Other uses of the computed costs may also be used.

In embodiment 100A, locations 110 includes four locations. This is for example purposes only. It should be understood that fewer or more locations may be present in other arrangements of embodiment 100, with items being transferred among the various locations. Indeed, many scores, hundreds, or thousands of locations of an entity may have items being received from other locations and/or sent to other locations.

FIG. 1B illustrates an embodiment 100B of transfers of items between multiple cost groups. In FIG. 1B, locations may be represented as cost groups. As such, each location of locations 110 of FIG. 1A may be represented as a cost group of cost groups 210. Each of cost groups 210 may share costs. In embodiment 100B, three cost groups are presented; this is for illustration purposes only. Fewer or greater numbers of cost groups may be present in other embodiments. Indeed, some embodiments may have tens, hundreds, or thousands of cost groups.

Within each cost group of cost groups 210, at least two pieces of information may be known: the initial quantity of a transferable item within the cost group at the beginning of the iteration process phase and the initial cost for each item of each cost group. Also known are the quantities of the item transferred among the various cost groups. Quantity T12 220-1 represents the quantity of a particular item transferred from cost group 1 210-1 to cost group 2 210-2; quantity T21 220-2 represents the quantity of the particular item transferred from cost group 2 210-2 to cost group 1 210-1; quantity T23 220-3 represents the quantity of the particular item transferred from cost group 2 210-2 to cost group 3 210-3; quantity T32 220-4 represents the quantity of the particular item transferred from cost group 3 210-3 to cost group 2 210-2; quantity T13 220-5 represents the quantity of the particular item transferred from cost group 1 210-1 to cost group 3 210-3; and quantity T31 220-6 represents the quantity of the particular item transferred from cost group 3 210-3 to cost group 1 210-1.

Each initial quantity is the quantity in the cost group at the start of the phase of the iteration process. The transfer quantities are for the same period of time such as a particular month, fiscal quarter, year, or other time period. Further, the PAC cost of each item is for the specific period of time.

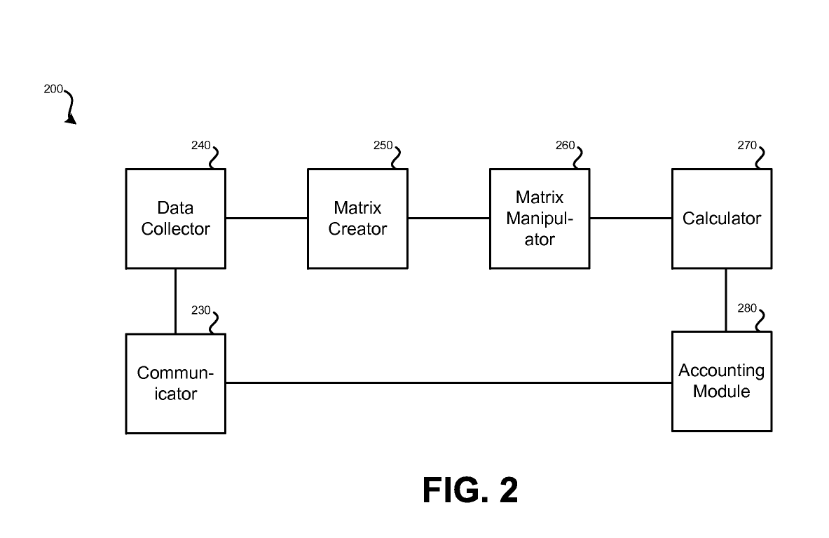

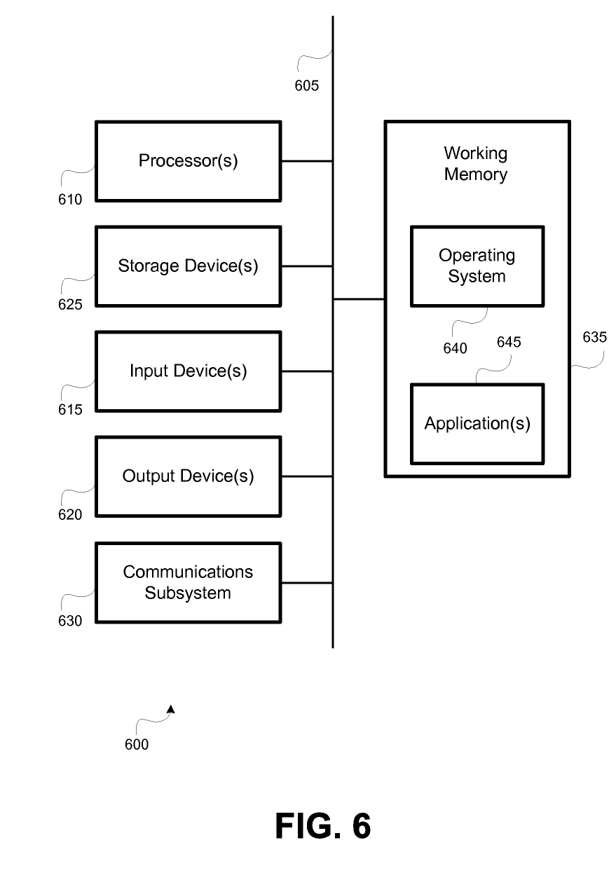

FIG. 2 illustrates an embodiment of a system 200 for creating and using a matrix based on an iterative periodic average costing equation evaluated for the infinite number of iterations for accounting purposes. The various modules of system 200 may be performed by one or more computer systems, such as computer system 600 FIG. 6. Each module of system 200 may be part of computer system 130-5 of FIG. 1B.

Communicator 230 may be used to communicate with one or more other systems to send and receive information. Communicator 230 may be configured to communicate with other devices in order to exchange information related to the number of cost groups, the location of cost groups, the initial quantity of transferrable items at cost groups, the cost of transferrable items at cost groups, and/or indications of transfers among cost groups. Data collector 240 may be configured to receive and/or request information related to the number of cost groups, the location of cost groups, the initial quantity of transferrable items at cost groups, the cost of transferrable items at cost groups, and/or indications of transfers among cost groups.

Information collected by data collector 240 via communicator 230 may be used by matrix creator 250. Matrix creator 250 may create one or more matrices in accordance with the methods described herein. Such matrices may be used to determine the iterative PAC for the infinite iteration. Matrix manipulator 260 may manipulate the matrices created by matrix creator 250. For example, matrix manipulator 260 may invert a matrix created by matrix creator 250. Other forms of algebraic manipulation may be performed by matrix manipulator 260.

Calculator 270, which may be a processor, may be used to calculate the costs for the infinite iteration according to the iterative PAC method. For example, calculation module may use Gauss Sidel, the Cramer rule, and LDU decomposition to calculate the costs of the transferable items using the matrices created by matrix creator 250 and/or the matrices as manipulated by matrix manipulator 260.

Accounting module 280 may allow the costs computed by calculator 270 to be incorporated into one or more accounting entities that require a PAC for the transferrable items. For example, one possible financial entity that accounting module 280 may incorporate the costs according to the infinite iteration PAC may be financial statements. Accounting module 280 may use communicator 230 to send the results to one or more other users, programs, and/or devices.

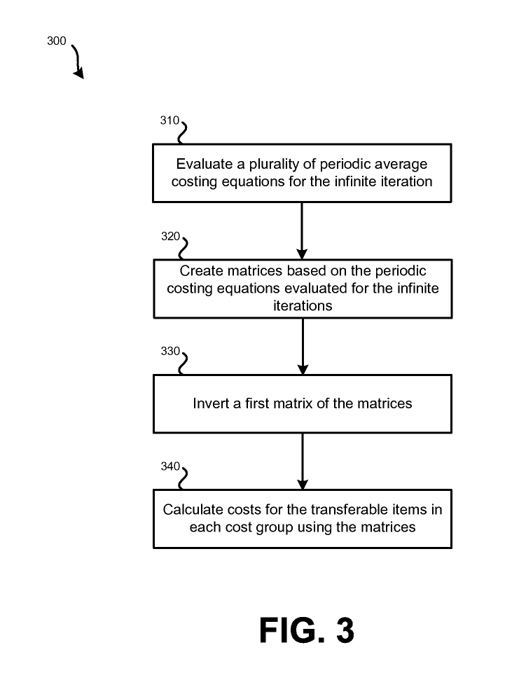

Various methods may be used to determine the periodic average cost using an iterative approach. Rather than performing some number of iterations of periodic average costing equations, the equations may be evaluated for the infinite iteration to provide a more accurate result. FIG. 3 illustrates an embodiment of a method 300 for creating and using a matrix based on an iterative periodic average costing equation evaluated for the infinite iteration. Each step of method 300 may be performed using a computer system, such as computer system 600 of FIG. 6. The following embodiment of method 300 is based on determining the iterative periodic average costing for the infinite iteration for embodiment 100B of FIG. 1B, as such, three cost groups are present. It should be understood that a similar approach may be used for a greater number (or a fewer number) of cost groups.

At step 310, a plurality of periodic average costing equations may be used. Equations 1 through 3 represent iterative periodic average costing equations that may be evaluated to determine the cost of the transferable items transferred among the cost groups of arrangement 100B of FIG. 1B.

$$\begin{matrix}{C}_{1} ( n ) = \frac{{Q}_{1} \cdot {C}_{1} ( 0 ) + {T}_{21} \cdot {C}_{2} ( n - 1 ) + {T}_{31} \cdot {C}_{3} ( n - 1 )}{{Q}_{1} + {T}_{21} + {T}_{31}} & Eq . 1 \\ {C}_{2} ( n ) = \frac{{Q}_{2} \cdot {C}_{2} ( 0 ) + {T}_{21} \cdot {C}_{1} ( n ) + {T}_{32} \cdot {C}_{3} ( n - 1 )}{{Q}_{2} + {T}_{12} + {T}_{32}} & Eq . 2 \\ {C}_{3} ( n ) = \frac{{Q}_{3} \cdot {C}_{3} ( 0 ) + {T}_{13} \cdot {C}_{1} ( n ) + {T}_{23} \cdot {C}_{2} ( n )}{{Q}_{3} + {T}_{13} + {T}_{23}} & Eq . 3\end{matrix}$$

In each equation, Qₘ represents the initial quantity of a particular item at the beginning of the iterative process phase in cost group m, Cₘ(0) represents the initial cost of a transferable item in cost group m (the cost just before the iteration process phase), Cₘ(n) represents the cost of a transferable item in cost group m as calculated for the nth iteration, and Tⱼₖ represents the quantity of the particular item transferred from cost group j to cost group k. As such, the cost of a transferable item according to the iterative periodic average costing equation for the nth iteration uses the costs determined for transferable items during the previous iteration. For the first iteration (Cₘ(1)), equations 1 through 3 use initial cost values assigned to each cost group for Cₘ(0).

As additional iterations of these equations are performed, the costs determined for transferable items within each cost group will become more accurate. However, performing enough iterations to obtain accurate costs may be computationally expensive (especially if many cost groups are present) and/or may be time-consuming. For example, it may take several hours for a computer to calculate multiple iterations for a significant number of cost groups. As such, these equations may be used to create a matrix that is solved for the infinite iteration that may require less computation power to solve, may be less time-consuming to compute, and/or may be more accurate than performing a set number of iterations.

Through algebraic manipulation, equation 1 may be manipulated to be equation 4, equation 2 may be manipulated to be equation 5, and equation 3 may be manipulated to be equation 6:

Q₁·C₁(n)=C₁(n)·(Q₁+T₂₁+T₃₁)−T₂₁−C₂(n−1)−T₃₁·C₃(n−1) Eq. 4

Q₂·C₂(n)=C₂(n)·(Q₂+T₁₂+T₃₂)−T₁₂−C₁(n)−T₃₂·C₃(n−1) Eq. 5

Q₃·C₃(n)=C₃(n)·(Q₃+T₁₃+T₂₃)−T₁₃−C₁(n)−T₂₃·C₂(n) Eq. 6

These equations can be further manipulated. Equation 4 may be manipulated to be equation 7, equation 5 may be manipulated to be equation 8, and equation 6 may be manipulated to be equation 9.

C₁(n)·(Q₁+T₂₁+T₃₁)−T₂₁·C₂(n−1)−T₃₁·C₃(n−1)=Q₁·C₁(0) Eq. 7

−T₁₂·C₁(n)+C₂(n)·(Q₂+T₁₂+T₃₂)−T₃₂·C₃(n−1)=Q₂·C₂(0) Eq. 8

−T₁₃·C₁(n)−T₂₃·C₂(n)+C₃(n)·(Q₃+T₁₃+T₂₃)=Q₃·C₃(0) Eq. 9

Since as additional iterations of the equations are performed, the cost calculated for transferable items in each cost group approaches the actual cost, at the infinite iteration, equations 10, 11, and 12 may be treated as true (the cost of an item in a cost group at the infinite iteration is the same as the cost of the item in the cost group at the infinite minus one iteration).

C₁(n)=C₁(n−1) Eq. 10

C₂(n)=C₂(n−1) Eq. 11

C₃(n)=C₃(n−1) Eq. 12

Using equations 10, 11, and 12, equations 7, 8, and 9 may be evaluated to be equations 13, 14, and 15, respectively:

C₁(n)·(Q₁+T₂₁+T₃₁)−T₂₁·C₂(n)−T₃₁·C₃(n)=Q₁·C₁(0) Eq. 13

−T₁₂·C₁(n)+C₂(n)·(Q₂+T₁₂+T₃₂)−T₃₂·C₃(n)=Q₂·C₂(0) Eq. 14

−T₁₃·C₁(n)−T₂₃·C₂(n)+C₃(n)·(Q₃+T₁₃+T₂₃)=Q₃·C₃(0) Eq. 15

At step 320 of method 300, matrices may be created based on the periodic costing equations evaluated for the infinite iterations of equations 13, 14, and 15. Equations 13, 14, and 15 may be rewritten in the form of matrices presented in equation 16.

$$( \begin{matrix}( {Q}_{1} + {T}_{21} + {T}_{31} ) & - {T}_{21} & - {T}_{31} \\ - {T}_{12} & ( {Q}_{2} + {T}_{12} + {T}_{32} ) & - {T}_{32} \\ - {T}_{13} & - {T}_{23} & ( {Q}_{3} + {T}_{13} + {T}_{23} )\end{matrix} ) ( \begin{matrix}{C}_{1} ( n ) \\ {C}_{2} ( n ) \\ {C}_{3} ( n )\end{matrix} ) = ( \begin{matrix}{Q}_{1} \cdot {C}_{1} ( 0 ) \\ {Q}_{2} \cdot {C}_{2} ( 0 ) \\ {Q}_{3} \cdot {C}_{3} ( 0 )\end{matrix} ) \qquad Eq . 16$$

In equation 16, the first matrix may be referred to as A, the second matrix may be referred to as C, and the third matrix as K. Equation 16 may be solved for matrix C. Solving for matrix C may involve multiplying matrix K by inverted matrix A at step 330. At step 340, calculating the values of Cₘ(n) of matrix C may be performed. Since n is infinite, Cₘ(n) is Cₘ. A variety of algorithms may be used to solve the matrices to determine Cₘ. For example, Gauss Sidel, the Cramer rule, and LDU decomposition may be used to solve such matrices for Cₘ. The resulting values of Cₘ may represent the costs that would be output if an infinite number of iterations of the iterative periodic average costing equations (equations 1, 2, and 3) were performed.

While equation 16 represents iterative periodic average costing equations evaluated for three cost groups, equation 16 may be generalized for m number of cost groups. Equation 17 represents an embodiment of equation 16 generalized for m number of cost groups.

$$( \begin{matrix}( {Q}_{1} + {T}_{21} + … + {T}_{j 1} + … + {T}_{m 1} ) & - {T}_{21} & … & … & - {T}_{m 1} \\ - {T}_{12} & ( {Q}_{2} + {T}_{12} + … + {T}_{j 2} + … + {T}_{m 2} ) & … & … & - {T}_{m 2} \\ - {T}_{13} & - {T}_{23} & … & … & - {T}_{m 3} \\ … & … & … & … & … \\ - {T}_{1 m} & - {T}_{2 m} & … & … & ( {Q}_{m} + {T}_{1 m} + … + {T}_{j 1} + … + {T}_{( m - 1 ) m} )\end{matrix} ) \cdot ( \begin{matrix}{C}_{1} \\ {C}_{2} \\ {C}_{3} \\ … \\ {C}_{m}\end{matrix} ) = ( \begin{matrix}{Q}_{1} \cdot {C}_{1} ( 0 ) \\ {Q}_{2} \cdot {C}_{2} ( 0 ) \\ {Q}_{3} \cdot {C}_{3} ( 0 ) \\ … \\ {Q}_{m} \cdot {C}_{m} ( 0 )\end{matrix} ) \qquad Eq . 17$$

In matrix A of equation 17, Qᵢ, where i is 1 to m, represents the initial quantity of ith cost group; Tᵢⱼ, where i is 1 to m and j is 1 to m, represents the quantity transferred from the ith cost group to the jth cost group. As such, for various numbers of cost groups, equation 17 may be used to solve for the cost of transferable items in each cost group. In matrix C of equation 17, Cᵢ, where i is 1 to m, represents the final cost (for the infinite iteration) from the equation for the ith cost group. In matrix K, where i is 1 to m, represents the initial quantity of items in the ith cost group, and Cᵢ(0), where i is 1 to m, represents the initial cost for items in each cost group. In equation 17, each row of the matrices corresponds to a particular cost group. Further, each cost group for which equation 17 is to be evaluated has a corresponding row in the matrices of equation 17.

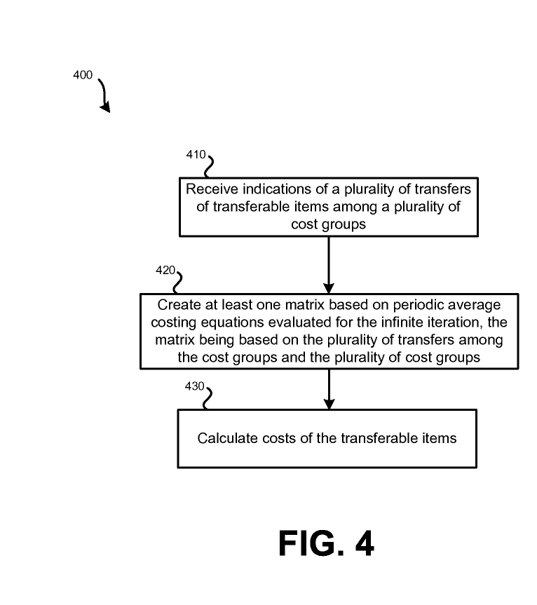

FIG. 4 illustrates an embodiment of a method 400 for using a matrix based on an iterative periodic average costing equation evaluated for the infinite iteration to determine costs of transferable items. Method 400 may involve the use of a matrix such as equation 17. Each step of method 400 may be performed using a computer system, such as computer system 600 of FIG. 6.

At step 410, indications of a plurality of transfers among a plurality of cost groups may be received. Other data, such as the initial quantity of items present in each cost group, and the initial cost of items in each cost group, may also be received or otherwise available.

At step 420, a matrix based on a periodic average costing equation evaluated for the infinite iteration may be created using the indications of the plurality of transfers among the plurality of cost groups, the initial quantity of items present in each cost group, and the initial cost of items in each cost group may also be received or otherwise available. The matrix created may be based on the matrix of equation 17. It should be understood that equation 17 may be algebraically manipulated. While equation 17 is in the form of A*C=K, equation 17, for example, could be rewritten as C=A⁻¹*K. Additionally, rather than creating matrices, it may be possible to maintain each periodic average costing equation evaluated for the infinite iteration separate, and evaluate as such.

Using the one or more matrices of step 420, the costs of transferable items within each cost group may be calculated at step 430. These costs may be calculated using, for example, Gauss Sidel, the Cramer rule, and LDU decomposition. The resulting calculated costs may match the costs that would be calculated for transferable items within the cost groups if an infinite number of iterations of the iterative periodic average costing equations were performed.

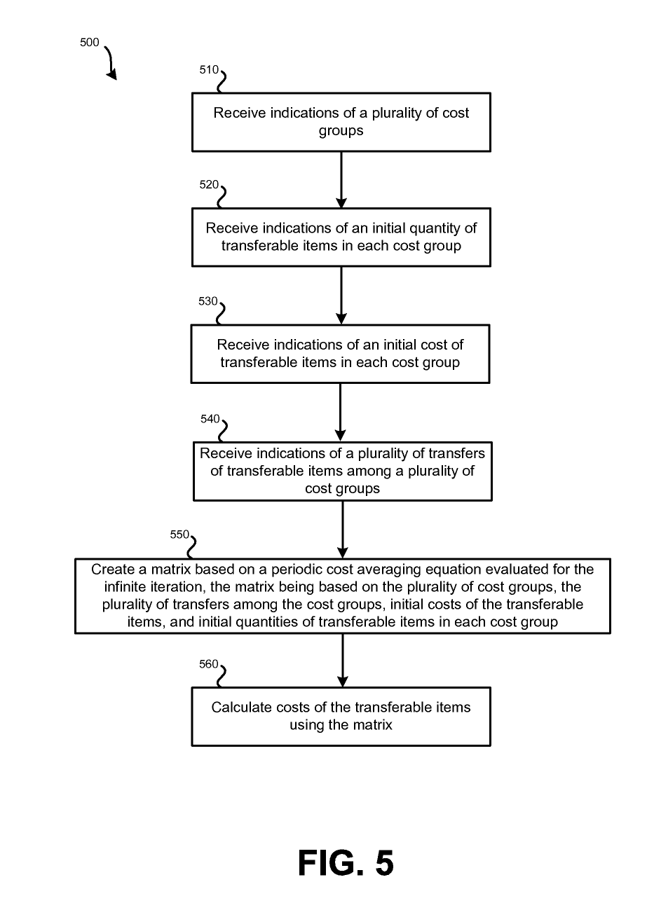

FIG. 5 illustrates another embodiment of a method 500 for using a matrix based on an iterative periodic average costing equation evaluated for the infinite iteration to determine costs of transferable items. Each step of method 500 may be performed by a computer system, such as computer system 600 of FIG. 6.

At step 510, indications of cost groups may be received. For example, various locations of a business may be identified as different cost groups. At step 520, indications of an initial quantity of transferable items in each cost group may be received. At step 530, indications of an initial cost of transferable items in each cost group may be received. At step 540, indications of a plurality of transfers among a plurality of the cost groups may be received.

At step 550, a matrix based on a periodic average costing equation evaluated for the infinite iteration may be created using the indications of the plurality of transfers among the plurality of cost groups, the initial quantity of items present in each cost group, and the initial cost of items in each cost group may also be received or otherwise available. The matrix created may be based on the matrix of equation 17. It should be understood that equation 17 may be algebraically manipulated. While equation 17 is in the form of A*C=K, equation 17, for example, could be rewritten as C=A⁻¹*K. Additionally, rather than creating matrices, it may be possible to maintain each periodic average costing equation evaluated for the infinite iteration separate.

The matrices created at step 550 may be based on equation 17 or some similar equation. The matrices may also be constructed by starting with a set of iterative periodic average costing equations and evaluating for the infinite iteration, as performed in method 300 of FIG. 3.

At step 560, using the one or more matrices of step 550, the costs of transferable items within each cost group may be calculated. These costs may be calculated using, for example, Gauss Sidel, the Cramer rule, and LDU decomposition. The resulting calculated costs may match the costs that would be calculated for transferable items within the cost groups if an infinite number of iterations of the iterative periodic average costing equations were performed.

FIG. 6 illustrates an embodiment of a computer system. A computer system as illustrated in FIG. 6 may be incorporated as part of the previously described computerized devices. For example, computer system 600 can perform the methods and evaluate the equations discussed herein. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements may include one or more processors 610, including without limitation one or more general-purpose processors and/or one or more special-purpose processors (such as digital signal processing chips, graphics acceleration processors, and/or the like); one or more input devices 615, which can include without limitation a mouse, a keyboard, and/or the like; and one or more output devices 620, which can include without limitation a display device, a printer, and/or the like.

The computer system 600 may further include (and/or be in communication with) one or more non-transitory storage devices 625, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

The computer system 600 might also include a communications subsystem 630, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 630 may permit data to be exchanged with a network (such as the network described below, to name one example), other computer systems, and/or any other devices described herein. In many embodiments, the computer system 600 will further comprise a working memory 635, which can include a RAM or ROM device, as described above. For instance, the various methods described herein may be performed over a network to allow a user to execute processing remotely. As such, a user may interact with a remote computer, communicating with a server to execute the various methods remote from the user.

The computer system 600 also can comprise software elements, shown as being currently located within the working memory 635, including an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 625 described above. In some cases, the storage medium might be incorporated within a computer system, such as the computer system 600. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 600) to perform methods in accordance with various embodiments of the invention. According to a set of embodiments, some or all of the procedures of such methods are performed by the computer system 600 in response to processor 610 executing one or more sequences of one or more instructions (which might be incorporated into the operating system 640 and/or other code, such as an application program 645) contained in the working memory 635. Such instructions may be read into the working memory 635 from another computer-readable medium, such as one or more of the storage device(s) 625. Merely by way of example, execution of the sequences of instructions contained in the working memory 635 might cause the processor(s) 610 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 600, various computer-readable media might be involved in providing instructions/code to processor(s) 610 for execution and/or might be used to store and/or carry such instructions/code (e.g., as signals). In many implementations, a computer-readable medium is a physical and/or tangible storage medium. Such a medium may take the form of a non-volatile media or volatile media. Non-volatile media include, for example, optical and/or magnetic disks, such as the storage device(s) 625. Volatile media include, without limitation, dynamic memory, such as the working memory 635.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600. These signals, which might be in the form of electromagnetic signals, acoustic signals, optical signals and/or the like, are all examples of carrier waves on which instructions can be encoded, in accordance with various embodiments of the invention.

The communications subsystem 630 (and/or components thereof) generally will receive the signals, and the bus 605 then might carry the signals (and/or the data, instructions, etc. carried by the signals) to the working memory 635, from which the processor(s) 605 retrieves and executes the instructions. The instructions received by the working memory 635 may optionally be stored on a storage device 625 either before or after execution by the processor(s) 610.

The methods, systems, and devices discussed above are examples. Various configurations may omit, substitute, or add various procedures or components as appropriate. For instance, in alternative configurations, the methods may be performed in an order different from that described, and/or various steps may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

What is claimed is:

1. A method for calculating costs of transferable items in accordance with an iterative periodic average costing model, the method comprising:
receiving, by a computer system, indications of a plurality of transfers of transferable items among cost groups of a plurality of cost groups;
creating, by the computer system, a plurality of matrices, wherein:
elements of each matrix correspond to iterative periodic average costing equations evaluated for an infinite iteration using the plurality of transfers of transferable items among cost groups of the plurality of cost groups; and
calculating, by the computer system, a cost of each transferable item within each cost group of the plurality of cost groups using the plurality of matrices.

2. The method for calculating costs of transferable items in accordance with the iterative periodic average costing model of claim 1, wherein:
each row of a matrix of the plurality of matrices corresponds to a different cost group of the plurality of cost groups; and
each cost group of the plurality of cost groups corresponds to a different row of the matrix of the plurality of matrices.

3. The method for calculating costs of transferable items in accordance with the iterative periodic average costing model of claim 2, wherein an element within a row of the matrix of the plurality of matrices indicates:
an initial quantity of transferable items within a cost group of the plurality of cost groups added with a quantity of transferable items received by the cost group from other cost groups of the plurality of cost groups.

4. The method for calculating costs of transferable items in accordance with the iterative periodic average costing model of claim 3, wherein a second element within the row of the matrix indicates:
a second quantity of transferable items received from another cost group of the plurality of cost groups.

5. The method for calculating costs of transferable items in accordance with the iterative periodic average costing model of claim 4, wherein calculating the cost of transferable items within each cost group of the plurality of cost groups using the plurality of matrices comprises:
calculating an inverse of the matrix to create an inverted matrix.

6. The method for calculating costs of transferable items in accordance with the iterative periodic average costing model of claim 5, wherein calculating the cost of the transferable items within each cost group of the plurality of cost groups using the plurality of matrices further comprises:
multiplying the inverted matrix by a second matrix of the plurality of matrices, wherein an element of the second matrix corresponds to an initial quantity of transferrable items and an initial cost of transferable items of a cost group of the plurality of cost groups.

7. The method for calculating costs of transferable items in accordance with the iterative periodic average costing model of claim 1, wherein each cost group of the plurality of cost groups represents a different physical location.

8. The method for calculating costs of transferable items in accordance with the iterative periodic average costing model of claim 1, wherein calculating the cost of transferable items within each cost group of the plurality of cost groups using the plurality of matrices having the elements of each matrix corresponding to the iterative periodic average costing equations evaluated for the infinite iteration results in the same costs of transferable items as calculating an infinite number of iterations of iterative periodic average costing equations.

9. A computer program product residing on a non-transitory processor-readable medium for calculating costs of transferable items in accordance with an iterative periodic average costing model, the computer program product comprising computer-readable instructions configured to cause a computer to:
receive indications of a plurality of transfers of transferable items among cost groups of a plurality of cost groups;
create a plurality of matrices, wherein:
elements of each matrix correspond to iterative periodic average costing equations evaluated for an infinite iteration using the plurality of transfers of transferable items among cost groups of the plurality of cost groups; and
calculate a cost of each transferable item within each cost group of the plurality of cost groups using the plurality of matrices having the elements of each matrix corresponding to the iterative periodic average costing equations evaluated for the infinite iteration.

10. The computer program product for calculating costs of transferable items in accordance with the iterative periodic average costing model of claim 9, wherein:
a first row of a matrix of the plurality of matrices corresponds to a first cost group of the plurality of cost groups; and
a second row of the matrix of the plurality of matrices corresponds to a second cost group of the plurality of cost groups.

11. The computer program product for calculating costs of transferable items in accordance with the iterative periodic average costing model of claim 10, wherein an element within the first row of the matrix of the plurality of matrices indicates:
an initial quantity of transferable items within the first cost group of the plurality of cost groups added with a quantity of transferable items received by the first cost group from other cost groups of the plurality of cost groups.

12. The computer program product for calculating costs of transferable items in accordance with the iterative periodic average costing model of claim 11, wherein a second element within the first row of the matrix indicates:
a second quantity of transferable items received from another cost group of the plurality of cost groups.

13. The computer program product for calculating costs of transferable items in accordance with the iterative periodic average costing model of claim 12, wherein the computer-readable instructions configured to cause the computer to calculate the cost of the transferable items within each cost group of the plurality of cost groups using the plurality of matrices further comprises computer-readable instructions configured to cause the computer to:
calculate an inverse of the matrix to create an inverted matrix.

14. The computer program product for calculating costs of transferable items in accordance with the iterative periodic average costing model of claim 13, wherein the computer-readable instructions configured to cause the computer to calculate the cost of the transferable items within each cost group of the plurality of cost groups using the plurality of matrices having rows evaluated for the infinite iteration further comprises computer-readable instructions configured to cause the computer to:
multiply the inverted matrix by a second matrix of the plurality of matrices, wherein an element of the second matrix corresponds to an initial quantity of transferrable items and an initial cost of transferable items of a cost group of the plurality of cost groups.

15. The computer program product for calculating costs of transferable items in accordance with the iterative periodic average costing model of claim 9, wherein each cost group of the plurality of cost groups represents a different physical location.

16. A system for calculating costs of transferable items in accordance with an iterative periodic average costing model, the system comprising:
a computer system, comprising:
a processor; and
a memory communicatively coupled with and readable by the processor and having stored therein processor-readable instructions which, when executed by the processor, cause the processor to:
receive indications of a plurality of transfers of transferable items among cost groups of a plurality of cost groups;
create a plurality of matrices, wherein:
elements of each matrix correspond to iterative periodic average costing equations evaluated for an infinite iteration using the plurality of transfers of transferable items among cost groups of the plurality of cost groups; and
calculate a cost of each transferable item within each cost group of the plurality of cost groups using the plurality of matrices having the elements of each matrix corresponding to the iterative periodic average costing equations evaluated for the infinite iteration.

17. The system for calculating costs of transferable items in accordance with the iterative periodic average costing model of claim 16, wherein:
each row of a matrix of the plurality of matrices corresponds to a different cost group of the plurality of cost groups; and
each cost group of the plurality of cost groups corresponds to a different row of the matrix of the plurality of matrices.

18. The system for calculating costs of transferable items in accordance with the iterative periodic average costing model of claim 17, wherein an element within a row of the matrix of the plurality of matrices indicates:
an initial quantity of transferable items within a cost group of the plurality of cost groups added with a quantity of transferable items received by the cost group from each other cost group of the plurality of cost groups.

19. The system for calculating costs of transferable items in accordance with the iterative periodic average costing model of claim 18, wherein a second element within each row of the matrix indicates:
a second quantity of transferable items received from another cost group of the plurality of cost groups.

20. The system for calculating costs of transferable items in accordance with the iterative periodic average costing model of claim 19, wherein the processor-readable instructions configured to cause the processor to calculate the cost of the transferable items within each cost group of the plurality of cost groups using the plurality of matrices further comprises processor-readable instructions configured to cause the processor to:
calculate an inverse of the matrix to create an inverted matrix.
